(19) United States
(12) Patent Application Publication
(10) Pub. No.: US 2025/0253921 A1
(43) Pub. Date: Aug. 7, 2025

(54) BEAM SELECTION METHOD AND DEVICE

(71) Applicant: Beijing Xiaomi Mobile Software Co., Ltd., Beijing (CN)

(72) Inventors: Yajun ZHU, Beijing (CN); Mingju LI, Beijing (CN); Qin MU, Beijing (CN)

(73) Assignee: Beijing Xiaomi Mobile Software Co., Ltd., Beijing (CN)

(21) Appl. No.: 18/856,280

(22) PCT Filed: Apr. 13, 2022
(86) PCT No.: PCT/CN2022/086720

§ 371 Date: Oct. 11, 2024

(51) Int. Cl. H04B 7/06

(52) U.S. Cl. CPC H04B 7/06958; H04B 7/0626; H04B 7/06968

(57) ABSTRACT

A beam selection method includes: receiving a beam measurement result of a reference beam sent by a terminal device; acquiring beam characteristic information of a receive beam used by the terminal device; and determining a target beam set according to the beam measurement result and the beam characteristic information.

### CROSS REFERENCE TO RELATED APPLICATION(S)

The present application is a U.S. National Stage of International Application No. PCT/CN2022/086720 filed on Apr. 13, 2022, the content of which is incorporated herein by reference in its entirety for all purposes.

### TECHNICAL FIELD

The present disclosure relates to the field of communication technology, and in particular to a beam selection method and device.

### BACKGROUND

With the development of communication technology, in order to increase the available bandwidth, the carrier frequency used in wireless communication is getting higher and higher. The impact brought thereby is that the path loss of radio waves in the high-frequency band becomes larger, resulting in a smaller coverage range of the cell. In order to compensate for the high path loss caused by the high-frequency band antenna, the antenna energy may be concentrated within a certain angle range through beamforming. Beamforming realizes the concentration of antenna energy in a specific direction, thereby expanding the coverage range of the cell in a specific direction. At the same time, due to the directivity of the beam, interferences between UEs located in different directions are reduced, thereby achieving an improvement in system capacity performance. At the base station side, wide beams generally refer to beams that provide cell coverage, such as omnidirectional beams of omnidirectional stations, or sector beams of three-sector stations, and narrow beams generally refer to beams that only cover part of a sector after beamforming. At the UE side, wide beams generally refer to omnidirectional beams, and narrow beams generally refer to beams that only cover part of a direction after beamforming. Sometimes, wide beams also refer to beams after beamforming, but their 3 dB beam width is larger. At this time, wide beams and narrow beams are relative concepts.

In a communication system based on beamforming, an important issue is how the access network device selects a service beam for the terminal device.

### SUMMARY

Embodiments of the present disclosure provide a beam selection method and device.

In a first aspect, an embodiment of the present disclosure provides a beam selection method, which is performed by the access network device. The method includes: receiving a beam measurement result of a reference beam sent by a terminal device; acquiring beam characteristic information of a receive beam used by the terminal device; and determining a target beam set according to the beam measurement result and the beam characteristic information.

In a second aspect, an embodiment of the present disclosure provides another beam selection method, which is performed by the terminal device. The method includes: sending the beam measurement result of the reference beam to the access network device; and determining the beam characteristic information of the used receive beam. The beam characteristic information and the beam measurement result are used for determining the target beam set.

In a third aspect, an embodiment of the present disclosure provides a communication device. The communication device includes a processor and a memory. The memory stores a computer program. The processor executes the computer program stored in the memory, so that the communication device performs the method described in the first aspect.

In a fourth aspect, an embodiment of the present disclosure provides a communication device. The communication device includes a processor and a memory. The memory stores a computer program. The processor executes the computer program stored in the memory, so that the communication device performs the method described in the second aspect.

### BRIEF DESCRIPTION OF THE DRAWINGS

In order to more clearly illustrate the technical solutions in the embodiments of the present disclosure or the background technology, the drawings required for use in the embodiments of the present disclosure or the background technology will be described below.

FIG. 1 is an architecture diagram of a communication system provided by an embodiment of the present disclosure;

FIG. 2 is a flow chart of a beam selection method provided by an embodiment of the present disclosure;

FIG. 3 is a flow chart of another beam selection method provided by an embodiment of the present disclosure;

FIG. 4 is a flow chart of another beam selection method provided by an embodiment of the present disclosure;

FIG. 5 is a flow chart of another beam selection method provided by an embodiment of the present disclosure;

FIG. 6 is a flow chart of another beam selection method provided by an embodiment of the present disclosure;

FIG. 7 is a flow chart of another beam selection method provided by an embodiment of the present disclosure;

FIG. 8 is a structural diagram of a communication apparatus provided by an embodiment of the present disclosure;

FIG. 9 is a structural diagram of a communication device provided by an embodiment of the present disclosure;

FIG. 10 is a schematic structural diagram of a chip provided by an embodiment of the present disclosure.

### DETAILED DESCRIPTION OF THE EMBODIMENTS

For ease of understanding, several technical terms involved in the embodiments of the present disclosure are briefly introduced below.

Beam is a communication resource. Beam may be a wide beam, a narrow beam, or other types of beams. The technology for forming a beam may be a beamforming technology or other technical means. The beamforming technology may be specifically a digital beamforming technology, an analog beamforming technology, a hybrid digital/analog beamforming technology, etc. Different beams may be considered as different spatial resources. The same information or different information may be sent through different beams. Optionally, multiple beams with the same or similar communication characteristics may be regarded as the same beam. Beams may be used on one or more antenna ports for transmitting data channels, control channels, and detection signals. For example, a transmit beam may refer to a distribution of directional signal strength formed after a signal is weighted and sent by an antenna array element. A receive beam may refer to a distribution of directional signal strength formed after a signal is weighted and received by an antenna array element. It can be understood that one or more antenna ports forming a beam may also be regarded as an antenna port set. A beam may also be embodied in the protocol as a spatial filter.

Reference beam refers to a beam configured by the access network device (such as a base station, etc.) for the terminal device to transmit data. The access network device and the terminal device may establish a communication link based on these beams, including a control channel for transmitting control information, or a data channel for transmitting data information. That is, the reference beam is a beam configured by the access network device for the terminal device to transmit data (which may include service data and control data, that is, data information and control information).

The link recovery procedure of a downlink beam is defined in the NR standard. The procedure includes beam failure detection, candidate beam scanning, beam recovery request sending, and beam recovery request response.

For the beam failure detection process, the access network device defines a series of periodic reference signals (RS) and uses reference beams to send these reference signals. The set of these periodic detection RSs is called the q0 set in the standard. As an example, RS may be one or more of a synchronization signal block (SSB) or a channel state information-reference signal (CSI-RS).

In order to better understand a beam selection method and apparatus disclosed in an embodiment of the present disclosure, the following first describes a communication system applicable to the embodiments of the present disclosure.

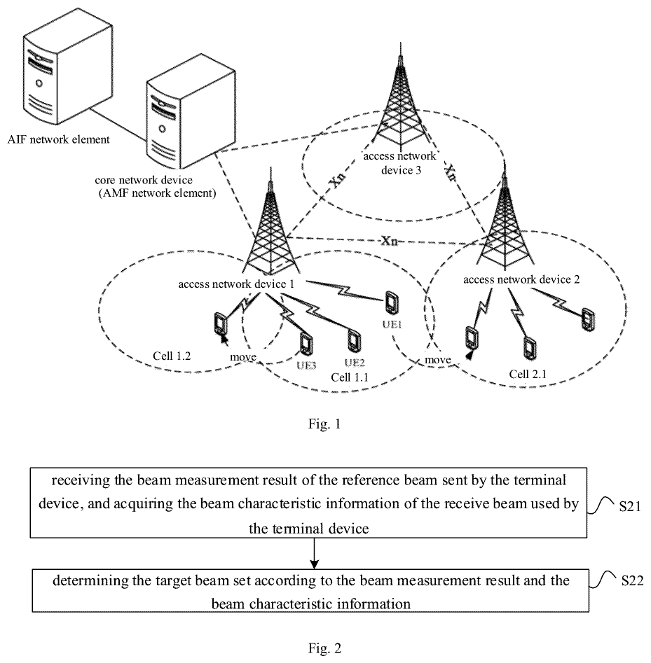

Reference may be made to FIG. 1, which is a schematic diagram of a communication system provided in an embodiment of the present disclosure. As shown in FIG. 1, the communication system may include an access network device, multiple terminal devices, and a core network device. The access network devices communicate with each other in a wired or wireless mode, for example, through the Xn interface in FIG. 1. The access network device may cover one or more cells. For example, access network device 1 covers cell 1.1 and cell 1.2, and access network device 2 covers cell 2.1. The terminal device may reside on the access network device in one of the cells and be in a connected state. Further, the terminal device may be converted from a connected state to an inactive state (that is, converted to a disconnected state) through an RRC release process. The terminal device in a disconnected state may reside in the original cell, and perform uplink transmission and/or downlink transmission with the access network device in the original cell according to the transmission parameters of the terminal device in the original cell. The terminal device in a disconnected state may also move to a new cell, and perform uplink transmission and/or downlink transmission with the access network device of the new cell according to the transmission parameters of the terminal device in the new cell.

It should be noted that FIG. 1 is only an example framework diagram, and the number of nodes, the number of cells, and the state of the terminal included in FIG. 1 are not limited. In addition to the functional nodes shown in FIG. 1, other nodes may also be included, such as core network device, gateway device, application server, etc., which are not limited. The access network device communicates with the core network device through wired or wireless means, such as communicating with each other through the next generation (NG) interface.

The access network device is mainly used to implement at least one function of resource scheduling, wireless resource management, or wireless resource control of the terminal device. Specifically, the access network device may include any node of a base station, a wireless access point, a transmission reception point (TRP), a transmission point (TP), or some other access nodes. In an embodiment of the present disclosure, the device for realizing the function of the access network device may be an access network device. Alternatively, it may be an apparatus capable of supporting the access network device to realize such function, such as a chip system. The apparatus may be installed in the access network device or used in combination with the access network device. In the technical solution provided by the embodiments of the present disclosure, an example is used, where the apparatus for realizing the function of the access network device is the access network device, for the purpose of describing the technical solution provided by the embodiments of the present disclosure.

The core network device may include AMF and/or a location management function network element. Optionally, the location management function network element includes a location server. The location server may be implemented as any one of the following: Location Management Function (LMF) network element, Enhanced Serving Mobile Location Centre (E-SMLC), Secure User Plane Location (SUPL), or SUPL Location Platform (SUPL SLP).

The terminal device is an entity on the user side for receiving or transmitting signals, such as a mobile phone. The terminal device may also be called a terminal, user equipment (UE), mobile station (MS), mobile terminal (MT), etc. The terminal device may be a car with communication function, a smart car, a mobile phone, a wearable device, a Pad, a computer with wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The embodiments of the present disclosure do not limit the specific technology and specific device form adopted by the terminal device.

The AMF network element is mainly responsible for the access authentication, mobility management, signaling interaction between various functional network elements, etc. of the terminal device, such as managing the user's registration status, user's connection status, user registration and network entry, tracking area update, cell switching user authentication, and key security.

The AIF network element is connected to the core network device (AMF network element) through a wired or wireless interface, and is mainly responsible for training the artificial intelligence AI model parameters.

It should be noted that the technical solution in the embodiments of the present disclosure may be applied to various communication systems, for example long term evolution (LTE) system, fifth generation (5G) mobile communication system, 5G new radio (NR) system, or other future new mobile communication systems. It should also be noted that the side link in the embodiments of the present disclosure may also be called a side link path or a through link.

It should be understood that the communication system is described in the embodiments of the present disclosure to more clearly illustrate the technical solution in the embodiments of the present disclosure, and this does not constitute any limitation on the technical solution provided by the embodiments of the present disclosure. It is known to those skilled in the art that with the evolution of the system architecture and the emergence of new business scenarios, the technical solution provided by the embodiments of the present disclosure is also applicable to similar technical problems.

In view of above, an embodiment of the present disclosure provides a beam selection method and apparatus to at least solve the problems existing in the relevant technology.

Reference may be made to FIG. 2, which is a flowchart of a beam selection method provided by an embodiment of the present disclosure.

As shown in FIG. 2, the method is performed by the access network device, and the method may include, but is not limited to, the following steps.

S21, receiving the beam measurement result of the reference beam sent by the terminal device, and acquiring the beam characteristic information of the receive beam used by the terminal device.

It may be understood that after the terminal device accesses the network, the access network device may configure a reference signal for beam selection. Different reference signals correspond to different reference beams. The terminal device receives the reference signal, measures the reference signal, and selects a reference beam with better beam quality as the receive beam for receiving the downlink signal of the access network device.

After measuring the reference signal, the terminal device may send the beam measurement result of the reference beam corresponding to the reference signal to the access network device. When the access network device is configured with multiple reference signals corresponding to multiple reference beams, the beam measurement result sent by the terminal device to the access network device is the beam measurement result of multiple reference beams.

However, the access network device receives the beam measurement result sent by the terminal device, but is not clear about the receive beam selected by the terminal device.

In an embodiment of the present disclosure, the access network device acquires the beam characteristic information of the receive beam used by the terminal device.

The access network device may configure the beam characteristic information of the used receive beam for the terminal device, so that the beam characteristic information of the receive beam used by the terminal device is acquired. Alternatively, the access network device may also receive the beam characteristic information of the used receive beam reported by the terminal device, so that the beam characteristic information of the receive beam used by the terminal device is acquired. Alternatively, the access network device may also acquire the beam characteristic information of the receive beam used by the terminal device according to the pre-determined receive beam selected by the terminal device.

S22, determining the target beam set according to the beam measurement result and the beam characteristic information.

In an embodiment of the present disclosure, the access network device receives the beam measurement result reported by the terminal device, acquires the beam-specific information of the receive beam used by the terminal device, and determines the target beam set, where the target beam set includes at least one target beam.

In an embodiment of the present disclosure, the target beam may be a target downlink transmit beam for the access network device to send a downlink signal. Alternatively, the target beam may be a target uplink receive beam for the access network device to receive an uplink signal. Alternatively, the target beam may be a target uplink transmit beam for the terminal device to send an uplink signal. Alternatively, the target beam may be a target downlink receive beam for the terminal device to receive a downlink signal.

The target beam set includes at least one target beam. The target beam set may include at least one target downlink transmit beam of the access network device, and/or at least one target uplink receive beam of the access network device, and/or at least one target uplink transmit beam of the terminal device, and/or at least one target downlink receive beam of the terminal device.

For example, determining the target beam set may include: determining at least one target downlink transmit beam of the access network device, or determining at least one target downlink receive beam of the terminal device, or determining at least one target downlink transmit beam of the access network device and at least one target downlink receive beam of the terminal device, or determining that the target beam set is at least one target narrow beam selected based on the signal quality of multiple narrow beams which is predicted according to the beam measurement result.

It may be understood that the access network device may predict the signal quality of multiple narrow beams for the beam measurement result reported by the terminal device, and further determine the target beam set based on the predicted signal quality of multiple narrow beams.

When the determined target beam set includes at least one target downlink transmit beam of the access network device, the access network device may send a downlink signal to the terminal device on the target downlink transmit beam. When the determined target beam set includes at least one target uplink receive beam of the access network device, the access network device may receive the uplink signal sent by the terminal device on the target uplink receive beam. When the determined target beam set includes at least one target downlink receive beam of the terminal device, the terminal device may receive the downlink signal sent by the access network device on the target downlink receive beam. When the determined target beam set includes at least one target uplink transmit beam of the terminal device, the terminal device may send an uplink signal to the access network device on the target uplink transmit beam.

In some embodiments, S22, determining the target beam set according to the beam measurement result and the beam characteristic information, includes: determining the first beam set by the beam prediction model according to the beam measurement result and the beam characteristic information.

In an embodiment of the present disclosure, after acquiring the beam measurement result and the beam characteristic information, the access network device determines the first beam set according to the beam measurement result and the beam characteristic information, where the beam prediction model may be used. The beam prediction model may be an artificial intelligence AI model, such as a machine learning model, a deep learning model, a federated learning model, etc. Each model also includes various sub-model types, such as a deep learning model including a convolutional neural network model, a recursive neural network model, etc. The beam prediction model here may be the above model or a sub-model of the above model.

In an embodiment of the present disclosure, the beam prediction model may predict the signal quality received by the terminal device using multiple narrow beams according to the beam measurement result, where the beam measurement result is based on the wide beam reception and is sent by the terminal device. Further, the first beam set may be determined according to the predicted signal quality of the multiple narrow beams. The first beam set may include one or more first beams. The first beam may be one or more of the predicted multiple terminal-side narrow beams with better signal quality. The first beam may include at least one first beam. The target beam set may include at least one first downlink transmit beam of the access network device, and/or at least one first uplink receive beam of the access network device, and/or at least one first uplink transmit beam of the terminal device, and/or at least one first downlink receive beam of the terminal device.

The receive beam used by the terminal device may affect the prediction accuracy of the access network device. When the terminal device uses a wide beam for receiving, the beam measurement result using the wide beam sent by the terminal device may have a lower reference signal received power (RSRP) than the beam measurement result using a narrow beam.

In an embodiment of the present disclosure, the signal quality received by multiple narrow beams is predicted according to the beam measurement result through a beam prediction model, and a first beam set is determined, including one or more first beams. The beam-specific information includes the width information of the receive beam. When it is determined that the receive beam used by the terminal device is a wide beam according to the beam characteristic information, the first beam set is determined, and the appropriate beam may be accurately selected for the terminal device, thereby improving the transmission efficiency.

In some embodiments, the beam selection method provided by an embodiment of the present disclosure further includes: in response to the target beam set including the target downlink transmit beam, sending a downlink signal to the terminal device on the target downlink transmit beam.

In an embodiment of the present disclosure, after the access network device determines the target beam set, and when the target beam set includes the target downlink transmit beam while sending a downlink signal to the terminal device, the downlink signal may be sent to the terminal device on the target downlink transmit beam. This helps to improve the transmission efficiency.

In some embodiments, the beam selection method provided by an embodiment of the present disclosure further includes: in response to the target beam set including the target uplink receive beam, receiving the uplink signal sent by the terminal device on the target uplink receive beam.

In an embodiment of the present disclosure, after the access network device determines the target beam set, and when the target beam set includes the target uplink receive beam while receiving the uplink signal sent by the terminal device, the uplink signal sent by the terminal device may be received on the target uplink receive beam. This helps to improve the transmission efficiency.

By implementing the embodiments of the present disclosure, the access network device receives the beam measurement result of the reference beam sent by the terminal device, acquires the beam characteristic information of the receive beam used by the terminal device, and determines the target beam set according to the beam measurement result and the beam characteristic information. As a result, the access network device can accurately select an appropriate beam for the terminal device, thereby improving the transmission efficiency.

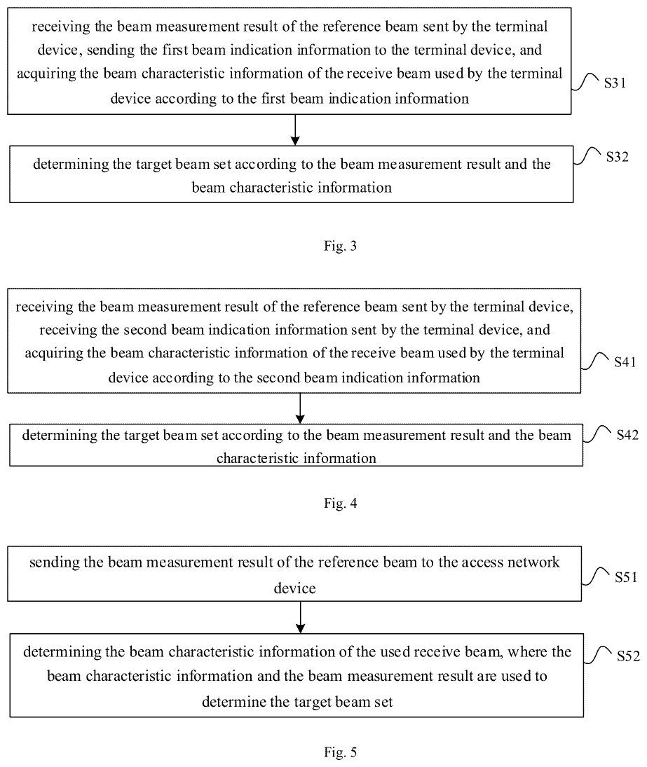

Reference may be made to FIG. 3, which is a flowchart of another beam selection method provided by an embodiment of the present disclosure.

As shown in FIG. 3, the method is performed by an access network device, and the method may include, but is not limited to, the following steps.

S31: receiving the beam measurement result of the reference beam sent by the terminal device, sending the first beam indication information to the terminal device, and acquiring the beam characteristic information of the receive beam used by the terminal device according to the first beam indication information.

The first beam indication information includes at least one of the following:
beam angle of direction information;
half-power beam width; or
quasi-co-location QCL information.

In an embodiment of the present disclosure, the access network device receives the beam measurement result of the reference beam sent by the terminal device, and the relevant description in the above embodiment may be referred to.

In an embodiment of the present disclosure, the first beam indication information may be determined by the transmission configuration indicator (TCI) field in the downlink control information (DCI).

In an embodiment of the present disclosure, the access network device sends the first beam indication information to the terminal device. The first beam indication information includes one or more of: the beam angle of direction information, the half-power beam width, or the quasi-co-location QCL information.

The beam angle of direction information may be such as [θ, φ], where θ represents the zenith angle, and φ represents the azimuth angle. Thus, the direction information of the receive beam may be determined according to the beam angle of direction information.

The half-power beam width may be also known as the 3 dB beam width, such as [θ, φ], where θ represents the horizontal beam width, and φ represents the vertical beam width. The horizontal beam width may be the angle between the two directions where the radiation power drops by 3 dB at both sides of the maximum radiation direction in the horizontal direction. The vertical beam width may be the angle between the two directions where the radiation power drops by 3 dB at both sides of the maximum radiation direction in the vertical direction. When the antenna with no maximum radiation and reception direction is called an omnidirectional antenna, a special value such as [0,0] may be used to represent the omnidirectional antenna, which is a special case for the 3 dB beam width. Therefore, the width information of the receive beam may be determined according to the 3 dB beam width.

The quasi-co-location QCL information means that the beam in the current reference signal has the same characteristics as the beam in the source reference signal. When the source reference signal is an uplink reference signal such as sounding reference signal (SRS), the QCL information reflects both the beam direction information and the beam width information.

In some embodiments, sending the first beam indication information to the terminal device includes: sending a first radio resource control RRC signaling to the terminal device where the first RRC signaling includes the first beam indication information.

In an embodiment of the present disclosure, an access network device sends a first Radio Resource Control (RRC) signaling to the terminal device, and the first RRC signaling includes the first beam indication information. For example, the first beam indication information is included in the CSI resource configuration associated with the Channel-State Information report configuration (CSI report config, or Channel-State Information report config).

In some embodiments, sending the first RRC signaling to the terminal device includes: sending channel state information CSI resource configuration information to the terminal device, where the CSI resource configuration information includes the first beam indication information.

As an example, the CSI report configuration includes a resourceForchannelmeasurement field, and this field corresponds to a certain CSI-ResourceConfigId. The configuration of CSI-ResourceConfigId indicates a certain CSI-RS resource. The configuration of CSI-RS resource includes the corresponding first beam indication information. The first beam indication information is the beam angle of direction information and/or half-power beam width and/or QCL information of the receive beam.

S32: determining the target beam set according to the beam measurement result and the beam characteristic information.

The detailed description about S32 in the embodiments of the present disclosure may refer to the relevant description in the above embodiment(s), and the same description is not repeated here.

It should be noted that S31 and S32 may be implemented separately or in combination with any other steps in the embodiments of the present disclosure, for example, in combination with S21 and S22 in the embodiments of the present disclosure, and the embodiments of the present disclosure are not limited in this regard.

Reference may be made to FIG. 4, which is a flowchart of another beam selection method provided by an embodiment of the present disclosure.

As shown in FIG. 4, the method is performed by an access network device, and the method may include, but is not limited to, the following steps.

S41: receiving the beam measurement result of the reference beam sent by the terminal device, receiving the second beam indication information sent by the terminal device, and acquiring the beam characteristic information of the receive beam used by the terminal device according to the second beam indication information.

The second beam indication information includes at least one of the following:
beam angle of direction information;
half-power beam width; or
quasi-co-location QCL information.

In an embodiment of the present disclosure, the access network device receives the beam measurement result of the reference beam sent by the terminal device, and the relevant description in the above embodiment(s) may be referred to.

In an embodiment of the present disclosure, the access network device receives the second beam indication information sent by the terminal device, and the second beam indication information includes one or more of: beam angle of direction information, half-power beam width, or quasi-co-location QCL information.

The beam angle of direction information may be, for example, [θ, φ], where θ represents the zenith angle, and φ represents the azimuth angle. Thus, the direction information of the receive beam may be determined according to the beam angle of direction information.

The half-power beamwidth may be also known as the 3 dB beamwidth, for example, [θ, φ], where θ represents the horizontal beam width and φ represents the vertical beam width. The horizontal beam width may be the angle between the two directions where the radiation power drops by 3 dB at both sides of the maximum radiation direction in the horizontal direction. The vertical beam width may be the angle between the two directions where the radiation power drops by 3 dB at both sides of the maximum radiation direction in the vertical direction. When the antenna with no maximum radiation and reception direction is called an omnidirectional antenna, a special value such as [0,0] may be used to represent the omnidirectional antenna, which is a special case for the 3 dB beam width. Thus, the width information of the receive beam may be determined based on the 3 dB beam width.

The quasi-co-location QCL information means that the beam in the current reference signal has the same characteristics as the beam in the source reference signal. When the source reference signal is an uplink reference signal such as sounding reference signal (SRS), the QCL information reflects both the beam direction information and the beam width information.

In some embodiments, receiving the second beam indication information sent by the terminal device includes: receiving the first uplink control information UCI signaling sent by the terminal device, where the first UCI signaling includes the second beam indication information.

In an embodiment of the present disclosure, the access network device receives the first uplink control information (UCI) signaling sent by the terminal device, and the first UCI signaling includes the first beam indication information. For example, the first beam indication information is included in the CSI report config.

In some embodiments, receiving the first UCI signaling sent by the terminal device includes: receiving the CSI sent by the terminal device, where the CSI includes the second beam indication information.

As an example, the CSI sent by the terminal device is a new CSI report type, which is Rx beam info. When the terminal device is configured to report this information, such as the report quantity is CRI-Rx_beam_info, the terminal device may report the CSI-RS resource index corresponding to the best RSRP and the corresponding second beam indication information. The second beam indication information is the beam angle of direction information and/or half-power beam width and/or QCL information of the receive beam.

S42: determining the target beam set according to the beam measurement result and the beam characteristic information.

The detailed description about S42 in the embodiments of the present disclosure may refer to the relevant description in the above embodiment(s), and the same description is not repeated here.

It should be noted that S41 and S42 may be implemented separately or in combination with any other steps in the embodiments of the present disclosure, for example, in combination with S21 and S22 in the embodiments of the present disclosure, and the embodiments of the present disclosure are not limited in this regard.

Reference may be made to FIG. 5, which is a flowchart of another beam selection method provided by an embodiment of the present disclosure.

As shown in FIG. 5, the method is performed by the terminal device, and the method may include, but is not limited to, the following steps.

S51: sending the beam measurement result of the reference beam to the access network device.

It may be understood that after the terminal device accesses the network, the access network device may configure a reference signal for beam selection. Different reference signals correspond to different reference beams. The terminal device receives the reference signal, measures the reference signal, and selects a reference beam with better beam quality as the receive beam for receiving the downlink signal of the access network device.

After measuring the reference signal, the terminal device may send the beam measurement result of the reference beam corresponding to the reference signal to the access network device. When the access network device is configured with multiple reference signals corresponding to multiple reference beams, the beam measurement result sent by the terminal device to the access network device is the beam measurement result of multiple reference beams.

However, the access network device receives the beam measurement result sent by the terminal device, but is not clear about the receive beam selected by the terminal device.

S52: determining the beam characteristic information of the used receive beam, where the beam characteristic information and the beam measurement result are used to determine the target beam set.

In an embodiment of the present disclosure, the terminal device determines the beam characteristic information of the receive beam used by the terminal device.

The access network device may configure the beam characteristic information of the used receive beam for the terminal device, so that the terminal device determines the beam characteristic information of the receive beam used by the terminal device. Alternatively, the terminal device may determine the beam characteristic information of the used receive beam by itself, so that the beam characteristic information of the receive beam used by the terminal device is acquired. Alternatively, the beam characteristic information of the receive beam used by the terminal device may also be acquired according to the pre-determined receive beam selected by the terminal device.

In an embodiment of the present disclosure, the beam characteristic information and the beam measurement result are used to determine the target beam set. The access network device receives the beam measurement result reported by the terminal device, acquires the beam-specific information of the receive beam used by the terminal device, and determines the target beam set, where the target beam set includes at least one target beam.

In an embodiment of the present disclosure, the target beam may be a target downlink transmit beam for the access network device to send a downlink signal, or a target uplink receive beam for the access network device to receive an uplink signal, or a target uplink transmit beam for the terminal device to send an uplink signal, or a target downlink receive beam for the terminal device to receive a downlink signal.

The target beam set includes at least one target beam. The target beam set may include at least one target downlink transmit beam of the access network device, and/or at least one target uplink receive beam of the access network device, and/or at least one target uplink transmit beam of the terminal device, and/or at least one target downlink receive beam of the terminal device.

For example, determining a target beam set may include: determining at least one target downlink transmit beam of the access network device, or determining at least one target downlink receive beam of the terminal device, or determining at least one target downlink transmit beam of the access network device and at least one target downlink receive beam of the terminal device, or determining that the target beam set is at least one target narrow beam selected based on the signal quality of multiple narrow beams which is predicted according to the beam measurement result.

It may be understood that the access network device may predict the signal quality of multiple narrow beams for the beam measurement result reported by the terminal device, and further, determine the target beam set based on the predicted signal quality of multiple narrow beams.

When the determined target beam set includes at least one target downlink transmit beam of the access network device, the access network device may send a downlink signal to the terminal device on the target downlink transmit beam. Alternatively, when the determined target beam set includes at least one target uplink receive beam of the access network device, the access network device may receive the uplink signal sent by the terminal device on the target uplink receive beam. When the determined target beam set includes at least one target downlink receive beam of the terminal device, the terminal device may receive the downlink signal sent by the access network device on the target downlink receive beam. When the determined target beam set includes at least one target uplink transmit beam of the terminal device, the terminal device may send an uplink signal to the access network device on the target uplink transmit beam.

In an embodiment of the present disclosure, after acquiring the beam measurement result and the beam characteristic information, the access network device determines the first beam set according to the beam measurement result and the beam characteristic information, where the beam prediction model may be used. The beam prediction model may be an artificial intelligence (AI) model, such as a machine learning model, a deep learning model, a federated learning model, etc. Each model also includes various sub-model types, such as a deep learning model including a convolutional neural network model, a recursive neural network model, etc. The beam prediction model here may be the above model or a sub-model of the above model.

In an embodiment of the present disclosure, the beam prediction model may predict the signal quality received by the terminal device using multiple narrow beams according to the beam measurement result which is based on wide beam reception and is sent by the terminal device. Further, the first beam set may be determined based on the predicted signal quality of the multiple narrow beams. The first beam set may include one or more first beams. The first beam may be one or more of the predicted multiple terminal-side narrow beams with better signal quality. The first beam may include at least one first beam. The target beam set may include at least one first downlink transmit beam of the access network device, and/or at least one first uplink receive beam of the access network device, and/or at least one first uplink transmit beam of the terminal device, and/or at least one first downlink receive beam of the terminal device.

The receive beam used by the terminal device may affect the prediction accuracy of the access network device. When the terminal device uses a wide beam for reception, the beam measurement result using the wide beam sent by the terminal device may have a lower reference signal received power (RSRP) than the beam measurement result using a narrow beam.

In an embodiment of the present disclosure, the signal quality received by multiple narrow beams is predicted according to the beam measurement result through a beam prediction model, and a first beam set is determined, including one or more first beams. The beam-specific information includes the width information of the receive beam. When it is determined according to the beam characteristic information that the receive beam used by the terminal device is a wide beam, the first beam set is determined. Thus, the appropriate beam can be accurately selected for the terminal device, thereby improving the transmission efficiency.

In some embodiments, the beam selection method provided by an embodiment of the present disclosure further includes: in response to the target beam set including the target downlink receive beam, receiving the downlink signal sent by the access network device on the target downlink receive beam.

In an embodiment of the present disclosure, after determining the target beam set, if the determined target beam set includes at least one target downlink receive beam of the terminal device, the terminal device may receive the downlink signal sent by the access network device on the target downlink receive beam. This helps to improve the transmission efficiency.

In some embodiments, the beam selection method provided by an embodiment of the present disclosure further includes: in response to the target beam set including the target uplink transmit beam, sending an uplink signal to the access network device on the target uplink transmit beam.

In an embodiment of the present disclosure, after determining the target beam set, if the determined target beam set includes at least one target uplink transmit beam of the terminal device, the terminal device may send an uplink signal to the access network device on the target uplink transmit beam. This helps to improve the transmission efficiency.

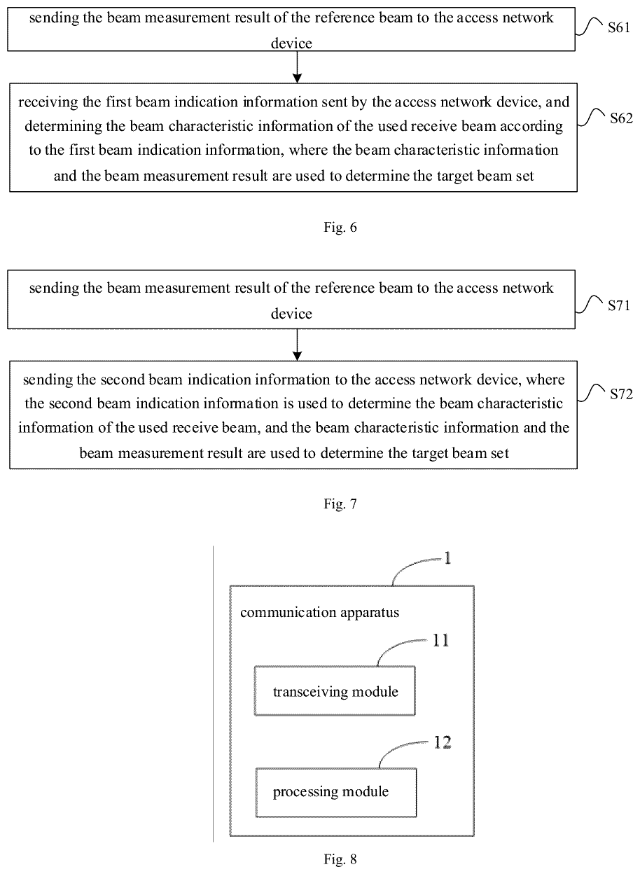

Reference may be made to FIG. 6, which is a flowchart of another beam selection method provided by an embodiment of the present disclosure.

As shown in FIG. 6, the method is applied to the terminal device, and the method may include, but is not limited to, the following steps.

S61: sending the beam measurement result of the reference beam to the access network device.

S62: receiving the first beam indication information sent by the access network device, and determining the beam characteristic information of the used receive beam according to the first beam indication information, where the beam characteristic information and the beam measurement result are used to determine the target beam set.

The first beam indication information includes at least one of the following:
beam angle of direction information;
half-power beam width; or
quasi-co-location QCL information.

In an embodiment of the present disclosure, the beam measurement result of the reference beam is sent to the access network device, and the relevant description in the above embodiment(s) may be referred to.

In an embodiment of the present disclosure, the access network device sends the first beam indication information to the terminal device. The first beam indication information includes one or more of: beam angle of direction information, half-power beam width, or quasi-co-location QCL information.

The beam angle of direction information may be, for example, [θ, φ], where θ represents the zenith angle, and φ represents the azimuth angle. Thus, the direction information of the receive beam may be determined according to the beam angle of direction information.

The half-power beam width is also known as the 3 dB beamwidth, for example, [θ, φ], where θ represents the horizontal beam width and φ represents the vertical beam width. The horizontal beam width may be the angle between the two directions where the radiation power drops by 3 dB at both sides of the maximum radiation direction in the horizontal direction. The vertical beam width may be the angle between the two directions where the radiation power drops by 3 dB at both sides of the maximum radiation direction in the vertical direction. When the antenna with no maximum radiation and reception direction is called an omnidirectional antenna, a special value such as [0,0] may be used to represent the omnidirectional antenna, which is a special case for the 3 dB beam width. Thus, the width information of the receive beam may be determined based on the 3 dB beam width.

The quasi-co-location QCL information means that the beam in the current reference signal has the same characteristics as the beam in the source reference signal. When the source reference signal is an uplink reference signal such as sounding reference signal (SRS), the QCL information reflects both the beam direction information and the beam width information.

In some embodiments, receiving the first beam indication information sent by the access network device includes: receiving the first RRC signaling sent by the access network device, where the first RRC signaling includes the first beam indication information.

In an embodiment of the present disclosure, the access network device sends a first Radio Resource Control (RRC) signaling to the terminal device, and the first RRC signaling includes the first beam indication information. For example, the first beam indication information is included in the CSI resource configuration associated with the CSI report config (Channel-State Information report config).

In some embodiments, receiving the first RRC signaling sent by the access network device includes: receiving the CSI resource configuration information sent by the access network device, where the CSI resource configuration information includes the first beam indication information.

As an example, the CSI report configuration includes a resourceForchannelmeasurement field, and this field corresponds to a certain CSI-ResourceConfigId. The configuration of CSI-ResourceConfigId indicates a certain CSI-RS resource. The configuration of CSI-RS resource includes corresponding first beam indication information. The first beam indication information is beam angle of direction information and/or half-power beam width and/or QCL information of the receive beam.

It should be noted that S61 and S62 may be implemented separately or in combination with any other step in the embodiments of the present disclosure, for example, in combination with S51 and S52 in the embodiments of the present disclosure, and the embodiments of the present disclosure are not limited in this regard.

Reference may be made to FIG. 7, which is a flowchart of another beam selection method provided by an embodiment of the present disclosure.

As shown in FIG. 7, the method is applied to a terminal device, and the method may include, but is not limited to, the following steps.

S71: sending the beam measurement result of the reference beam to the access network device.

S72: sending second beam indication information to the access network device, where the second beam indication information is used to determine the beam characteristic information of the used receive beam, and the beam characteristic information and the beam measurement result are used to determine the target beam set.

The second beam indication information includes at least one of the following:
beam angle of direction information;
3 dB beam width; or
quasi-co-location QCL information.

In an embodiment of the present disclosure, the access network device receives the beam measurement result of the reference beam sent by the terminal device, and the relevant description in the above embodiment(s) may be referred to.

In an embodiment of the present disclosure, the access network device receives the second beam indication information sent by the terminal device, and the second beam indication information includes one or more of: beam angle of direction information, half-power beam width, or quasi-co-location QCL information.

The beam angle of direction information may be, such as [θ, φ], where θ represents the zenith angle, and φ represents the azimuth angle. Thus, the direction information of the receive beam may be determined according to the beam angle of direction information.

The half-power beam width may be also known as the 3 dB beam width, such as [θ, φ], where θ represents the horizontal beam width, and φ represents the vertical beam width. The horizontal beam width may be the angle between the two directions where the radiation power drops by 3 dB at both sides of the maximum radiation direction in the horizontal direction. The vertical beam width may be the angle between the two directions where the radiation power drops by 3 dB at both sides of the maximum radiation direction in the vertical direction. When the antenna with no maximum radiation and reception direction is called an omnidirectional antenna, a special value such as [0,0] may be used to represent the omnidirectional antenna, which is a special case for the 3 dB beam width. Therefore, the width information of the receive beam may be determined according to the 3 dB beam width.

The quasi-co-location QCL information means that the beam in the current reference signal has the same characteristics as the beam in the source reference signal. When the source reference signal is an uplink reference signal such as sounding reference signal (SRS), the QCL information reflects both the beam direction information and the beam width information.

In some embodiments, sending the second beam indication information to the access network device includes: sending the first UCI signaling to the access network device, where the first UCI signaling includes the second beam indication information.

In an embodiment of the present disclosure, the access network device receives the first uplink control information (UCI) signaling sent by the terminal device, and the first UCI signaling includes the first beam indication information. For example, the first beam indication information is included in the CSI report config.

In some embodiments, sending the first UCI signaling to the access network device includes: sending CSI to the access network device, where the CSI includes the second beam indication information.

As an example, the CSI sent by the terminal device is a new CSI report type, which is Rx beam info. When the terminal device is configured to report this information, such as report quantity is CRI-Rx_beam_info, the terminal device may report the CSI-RS resource index corresponding to the best RSRP and the corresponding second beam indication information. The second beam indication information is the beam angle of direction information and/or half-power beam width and/or QCL information of the receive beam.

It should be noted that S71 and S72 may be implemented separately or in combination with any other steps in the embodiments of the present disclosure, for example, in combination with S51 and S52 in the embodiments of the present disclosure, and the embodiments of the present disclosure are not limited in this regard.

In the above embodiments provided by the present disclosure, the method provided by an embodiment of the present disclosure is introduced from the perspective of the terminal device and the access network device respectively. In order to realize the various functions in the method provided by the above embodiments of the present disclosure, the network device and the terminal device may include a hardware structure and a software module, and the above functions are realized in the form of a hardware structure, a software module, or a hardware structure plus a software module. One of the above functions may be implemented in the form of a hardware structure, a software module, or a hardware structure plus a software module.

Reference may be made to FIG. 8, which shows a structural diagram of a communication apparatus 1 provided by an embodiment of the present application. The communication apparatus 1 shown in FIG. 8 may include a transceiving module 11 and a processing module 12. The transceiving module 11 may include a sending module and/or a receiving module. The sending module is used to implement the sending function, and the receiving module is used to implement the receiving function. The transceiving module 11 may implement the sending function and/or the receiving function.

The communication apparatus 1 may be a terminal device, or an apparatus in a terminal device, or an apparatus that may be used with a terminal device. Alternatively, the communication apparatus 1 may be a network device, or an apparatus in a network device, or an apparatus that may be used with a network device.

The communication apparatus 1 is an access network device, including a transceiving module 11 and a processing module 12.

The transceiving module 11 is configured to: receive the beam measurement result of the reference beam sent by the terminal device, and acquire the beam characteristic information of the receive beam used by the terminal device.

The processing module 12 is configured to determine the target beam set according to the beam measurement result and the beam characteristic information.

In some embodiments, the transceiving module 11 is further configured to send first beam indication information to the terminal device.

The processing module 12 is further configured to acquire the beam characteristic information of the receive beam used by the terminal device according to the first beam indication information.

The first beam indication information includes at least one of the following:
beam angle of direction information;
half-power beam width; or
quasi-co-address QCL information.

In some embodiments, the transceiving module 11 is specifically configured to send a first radio resource control RRC signaling to the terminal device, where the first RRC signaling includes the first beam indication information.

In some embodiments, the transceiving module 11 is specifically configured to send channel state information CSI resource configuration information to the terminal device, where the CSI resource configuration information includes the first beam indication information.

In some embodiments, the transceiving module 11 is further configured to receive second beam indication information sent by the terminal device.

The processing module 12 is further configured to acquire the beam characteristic information of the receive beam used by the terminal device according to the second beam indication information.

The second beam indication information includes at least one of the following:
beam angle of direction information;
half-power beam width; or
quasi-co-address QCL information.

In some embodiments, the transceiving module 11 is specifically configured to receive the first uplink control information UCI signaling sent by the terminal device, where the first UCI signaling includes the second beam indication information.

In some embodiments, the transceiving module 11 is specifically configured to receive the CSI sent by the terminal device, where the CSI includes the second beam indication information.

In some embodiments, the processing module 12 is specifically configured to determine the first beam set by a beam prediction model according to the beam measurement result.

In some embodiments, the transceiving module 11 is further configured to send a downlink signal to the terminal device on a target downlink transmit beam in response to the target beam set including the target downlink transmit beam.

In some embodiments, the transceiving module 11 is further configured to receive the uplink signal sent by the terminal device on a target uplink receive beam in response to the target beam set including the target uplink receive beam.

The communication apparatus 1 is a terminal device, including a transceiving module 11 and a processing module 12.

The transceiving module 11 is configured to send the beam measurement result of the reference beam to the access network device.

The processing module 12 is configured to determine the beam characteristic information of the used receive beam, where the beam characteristic information and the beam measurement result are used to determine the target beam set.

In some embodiments, the transceiving module 11 is specifically configured to receive the first beam indication information sent by the access network device.

In some embodiments, the processing module 12 is specifically configured to determine the beam characteristic information of the used receive beam according to the first beam indication information.

The first beam indication information includes at least one of the following:
beam angle of direction information;
half-power beam width; or
quasi co-location QCL information.

In some embodiments, the transceiving module 11 is specifically configured to receive the first RRC signaling sent by the access network device, where the first RRC signaling includes the first beam indication information.

In some embodiments, the transceiving module 11 is specifically configured to receive the CSI resource configuration information sent by the access network device, where the CSI resource configuration information includes the first beam indication information.

In some embodiments, the transceiving module 11 is specifically configured to send second beam indication information to the access network device, where the second beam indication information is used to determine the beam characteristic information of the used receive beam.

The second beam indication information includes at least one of the following:
beam angle of direction information;
3 dB beam width; or
quasi-co-location QCL information.

In some embodiments, the transceiving module 11 is specifically configured to send a first UCI signaling to the access network device, where the first UCI signaling includes the second beam indication information.

In some embodiments, the transceiving module 11 is specifically configured to send CSI to the access network device, where the CSI includes the second beam indication information.

In some embodiments, the transceiving module 11 is further configured to receive a downlink signal sent by the access network device on a target downlink receive beam in response to the target beam set including the target downlink receive beam.

In some embodiments, the transceiving module 11 is further configured to send an uplink signal to the access network device on a target uplink transmit beam in response to the target beam set including the target uplink transmit beam.

Regarding the communication apparatus 1 in the above embodiment(s), the specific mode in which each module performs the operation has been described in detail in the embodiment(s) of the method, and will not be elaborated here.

The communication apparatus 1 provided in the above embodiment(s) of the present disclosure achieves the same or similar beneficial effects as the communication methods provided in some of the above embodiments, which will not be described in detail here.

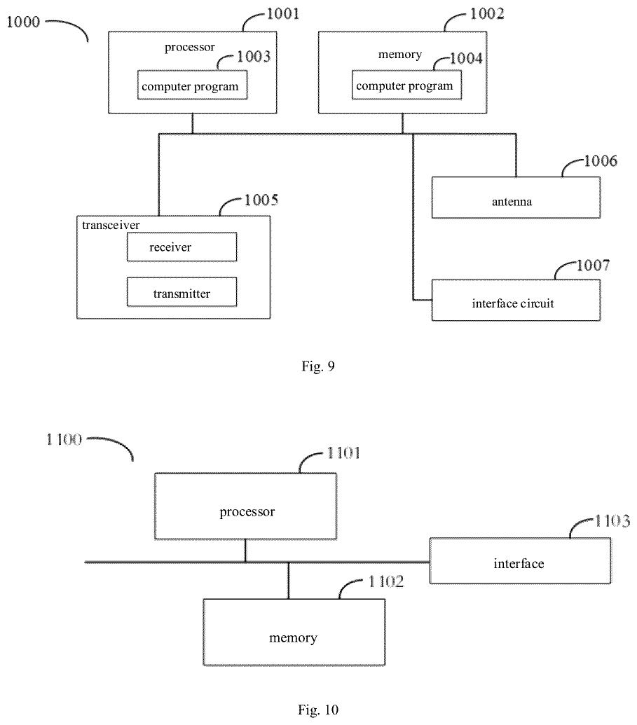

Reference may be made to FIG. 9, which shows a schematic structural diagram of a communication device 1000 provided by an embodiment of the present disclosure. The communication device 1000 may be an access network device or a terminal device, or may be a chip, a chip system, or a processor that supports the access network device to implement the above method(s), or may be a chip, a chip system, or a processor that supports the terminal device to implement the above method(s). The communication device 1000 may be used to implement the method described in the above method embodiment(s), and the details may be referred to in the description of the above method embodiment(s).

The communication device 1000 may be an access network device or a terminal device, or may be a chip, a chip system, or a processor that supports the access network device to implement the above method(s), or may be a chip, a chip system, or a processor that supports the terminal device to implement the above method(s). The communication device may be used to implement the method described in the above method embodiment(s), and the details may be referred to in the description of the above method embodiment(s).

The communication device 1000 may include one or more processors 1001. The processor 1001 may be a general-purpose processor or a dedicated processor, etc. For example, the processor 1001 may be a baseband processor or a central processor. The baseband processor may be used to process the communication protocol and the communication data. The central processor may be used to control the communication apparatus (such as a base station, a baseband chip, a terminal device, a terminal device chip, a DU or a CU, etc.), execute a computer program, and process the data of the computer program.

For example, the communication device 1000 may also include one or more memories 1002, on which a computer program 1004 may be stored. The memory 1002 executes the computer program 1004, so that the communication device 1000 performs the method described in the above method embodiment(s). As another example, data may also be stored in the memory 1002. The communication device 1000 and the memory 1002 may be provided separately or integrated together.

For example, the communication device 1000 may also include a transceiver 1005 and an antenna 1006. The transceiver 1005 may be referred to as a transceiving unit, a transceiving machine, or a transceiving circuit, etc., for realizing the transceiving function. The transceiver 1005 may include a receiver and a transmitter. The receiver may be referred to as a receiving machine or a receiving circuit, etc., for implementing the receiving function. The transmitter may be referred to as a transmitting machine or a transmitting circuit, etc., for implementing the transmitting function.

For example, the communication device 1000 may also include one or more interface circuits 1007. The interface circuit 1007 is used to receive code instructions and transmit them to the processor 1001. The processor 1001 runs the code instructions to enable the communication device 1000 to perform the method described in the above method embodiment(s).

The communication device 1000 is an access network device. The transceiver 1005 is used to execute S21 in FIG. 2, S31 in FIGS. 3, and S41 in FIG. 4. The processor 1001 is used to execute S22 in FIG. 2, S32 in FIGS. 3, and S42 in FIG. 4.

The communication device 1000 is a terminal device. The transceiver 1005 is used to execute S51 in FIGS. 5, S61 and S62 in FIGS. 6, and S71 and S72 in FIG. 7. The processor 1001 is used to execute S52 in FIG. 5.

In an implementation, the processor 1001 may include a transceiver for implementing the receiving and sending functions. For example, the transceiver may be a transceiving circuit, or an interface, or an interface circuit. The transceiving circuit, interface, or interface circuit for implementing the receiving and sending functions may be separate or integrated together. The above-mentioned transceiving circuit, interface, or interface circuit may be used for reading and writing code/data. Alternatively, the above-mentioned transceiving circuit, interface, or interface circuit may be used for transmission or delivery of signals.

In an implementation, the processor 1001 may store a computer program 1003. The computer program 1003 runs on the processor 1001, so that the communication device 1000 performs the method described in the above method embodiment(s). The computer program 1003 may be solidified in the processor 1001, in which case the processor 1001 may be implemented by hardware.

In an implementation, the communication device 1000 may include a circuit that may implement the functions of sending or receiving or communicating in the aforementioned method embodiment(s). The processor and transceiver described in the present disclosure may be implemented in an integrated circuit (IC), an analog IC, a radio frequency integrated circuit RFIC, a mixed signal IC, an application specific integrated circuit (ASIC), a printed circuit board (PCB), an electronic device, etc. The processor and transceiver may also be manufactured using various IC processing technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication device described in the above embodiments may be a terminal device, but the scope of the communication device described in the present disclosure is not limited thereto, and the structure of the communication device may not be limited to FIG. 9. The communication device may be an independent device or may be part of a larger device. For example, the communication device may be:
(1) an independent integrated circuit IC, or a chip, or a chip system or subsystem;
(2) a collection of one or more ICs, such as the IC collection may also include a storage component for storing data or a computer program;
(3) an ASIC, such as a modem;
(4) a module that may be embedded in other devices;
(5) a receiver, a terminal device, an intelligent terminal device, a cellular phone, a wireless device, a handheld device, a mobile unit, a vehicle-mounted device, a network device, a cloud device, an artificial intelligence device, etc.;
(6) others, etc.

For a case where the communication device may be a chip or a chip system, reference may be made to FIG. 10, which is a structural diagram of a chip provided by an embodiment of the present disclosure.

The chip 1100 includes a processor 1101 and an interface 1103. The number of processors 1101 may be one or more, and the number of interfaces 1103 may be multiple.

For a case where the chip is used to implement the functions of the terminal device in the embodiments of the present disclosure, the following applies.

The interface 1103 is used to receive code instructions and transmit them to the processor.

The processor 1101 is used to execute the code instructions to perform the beam selection method described in some of the above embodiments.

For a case where the chip is used to implement the functions of the access network device in the embodiments of the present disclosure, the following applies.

The interface 1103 is used for receiving code instructions and transmitting them to the processor.

The processor 1101 is used for running the code instructions to perform the beam selection method as described in some of the above embodiments.

As an example, the chip 1100 further includes a memory 1102, which is used to store necessary computer programs and data.

Those skilled in the art may also understand that the various illustrative logical blocks and steps listed in the embodiments of the present disclosure may be implemented by electronic hardware, computer software, or a combination of the two. Whether such functions are implemented by hardware or software depends on the specific application and the design requirements of the entire system. Those skilled in the art may use various methods to implement the functions for each specific application, but such implementation should not be understood as exceeding the protection scope of the embodiments of the present disclosure.

The embodiments of the present disclosure also provide a communication system. The communication system includes the communication apparatus acting as a terminal device and the communication apparatus acting as an access network device in the embodiment of FIG. 8 above. Alternatively, the communication system includes the communication apparatus acting as a terminal device and the communication apparatus acting as an access network device in the embodiment of FIG. 9 above.

The present disclosure also provides a readable storage medium on which instructions are stored. When the instructions are executed by a computer, the functions of any of the above-mentioned method embodiments are accomplished.

The present disclosure also provides a computer program product, which, when executed by a computer, implements the functions of any of the above-mentioned method embodiments.

The above-mentioned embodiments may be implemented in whole or in part by software, hardware, firmware, or any combination thereof. When implemented by software, it may be implemented in whole or in part in the form of a computer program product. The computer program product includes one or more computer programs. When the computer program is loaded and executed on a computer, the processes or functions described in the embodiments of the present disclosure are generated in whole or in part. The computer may be a general-purpose computer, a special-purpose computer, a computer network, or other programmable device. The computer program may be stored in a computer-readable storage medium, or transmitted from one computer-readable storage medium to another computer-readable storage medium. For example, the computer program may be transmitted from one website site, computer, server, or data center to another website site, computer, server, or data center by wired means (e.g., coaxial cable, optical fiber, digital subscriber line (DSL)) or wireless means (e.g., infrared, wireless, microwave, etc.). The computer-readable storage medium may be any available medium that can be accessed by a computer, or may be a data storage device such as a server or a data center that includes one or more available media. The available medium may be a magnetic medium (e.g., a floppy disk, a hard disk, a tape), an optical medium (e.g., a high-density digital video disc (DVD)), or a semiconductor medium (e.g., a solid state disk (SSD)).

A person skilled in the art may understand that the various digital numbers such as first and second involved in the present disclosure are only used for the convenience of description and are not used to limit the scope of the embodiments of the present disclosure. These digital numbers are also used to indicate the order of precedence.

At least one in the present disclosure may also be described as one or more, and a plurality may be two, three, four or more, which is not limited in the present disclosure. In embodiments of the present disclosure, for a specific technical feature, the technical features in the same type of technical features are distinguished by “first”, “second”, “third”, “A”, “B”, “C” and “D”, etc., and there is no order of precedence or size between these technical features described by “first”, “second”, “third”, “A”, “B”, “C”, and “D”.

The correspondences shown in the tables of the present disclosure may be configured or pre-defined. The values of the information in each table are only examples, and may be configured as other values, which are not limited by the present disclosure. When configuring the correspondence between information and each parameter, it is not necessarily required to configure all the correspondences illustrated in each table. For example, in the table of the present disclosure, the correspondences shown in some rows may not be configured. For another example, appropriate deformation adjustments may be made based on the above table, such as splitting, merging, etc. The names of the parameters shown in the titles of the above tables may also use other names that can be understood by the communication device. The values or representations of the parameters may also be other values or representations that can be understood by the communication device. When implementing the above tables, other data structures may also be used, such as arrays, queues, containers, stacks, linear lists, pointers, linked lists, trees, graphs, structures, classes, heaps, hash tables, or hashing tables.

The pre-definition in the present disclosure may be understood as definition, definition in advance, storage, pre-storage, pre-negotiation, pre-configuration, solidification, or pre-burning.

A person of ordinary skill in the art may realize that the units and algorithm steps of each example described in conjunction with the embodiments disclosed herein may be implemented in electronic hardware, or a combination of computer software and electronic hardware. Whether these functions are performed in hardware or software depends on the specific application and design constraints of the technical solution. Professional technicians may use different methods to implement the described functions for each specific application, but such implementation should not be considered to go beyond the scope of the present disclosure.

Technical personnel in the relevant field may clearly understand that for the convenience and simplicity of description, the specific working process of the system, device, and unit described above may refer to the corresponding process in the aforementioned method embodiment(s), and will not be repeated here.

The above is only a specific implementation method of the present disclosure, but the protection scope of the present disclosure is not limited thereto. Any technician familiar with the technical field may easily think of changes or replacements within the technical scope revealed by the present disclosure, which should be covered within the protection scope of the present disclosure. Therefore, the protection scope of the present disclosure shall be based on the protection scope of the claims.

1. A beam selection method, performed by an access network device and comprising:
receiving a beam measurement result of a reference beam sent by a terminal device;
acquiring beam characteristic information of a receive beam used by the terminal device; and
determining a target beam set according to the beam measurement result and the beam characteristic information.

2. The method according to claim 1, wherein acquiring the beam characteristic information of the receive beam used by the terminal device comprises:
sending first beam indication information to the terminal device; and
acquiring the beam characteristic information of the receive beam used by the terminal device according to the first beam indication information,
wherein the first beam indication information comprises at least one of:
beam angle of direction information;
half-power beam width; or
quasi-co-location QCL information.

3. The method according to claim 2, wherein sending the first beam indication information to the terminal device comprises:
sending a first radio resource control RRC signaling to the terminal device, wherein the first RRC signaling comprises the first beam indication information.

4. The method according to claim 3, wherein sending the first RRC signaling to the terminal device comprises:
sending channel state information CSI resource configuration information to the terminal device, wherein the CSI resource configuration information comprises the first beam indication information.

5. The method according to claim 1, wherein acquiring the beam characteristic information of the receive beam used by the terminal device comprises:
receiving second beam indication information sent by the terminal device; and
acquiring the beam characteristic information of the receive beam used by the terminal device according to the second beam indication information,
wherein the second beam indication information comprises at least one of:
beam angle of direction information;
half-power beam width; or
quasi-co-location QCL information.

6. The method according to claim 5, wherein receiving the second beam indication information sent by the terminal device comprises:
receiving first uplink control information UCI signaling sent by the terminal device, wherein the first UCI signaling comprises the second beam indication information.

7. The method according to claim 6, wherein receiving the first UCI signaling sent by the terminal device comprises:
receiving CSI sent by the terminal device, wherein the CSI comprises the second beam indication information.

8. The method according to claim 1, wherein determining the target beam set according to the beam measurement result and the beam characteristic information comprises:
determining the first beam set by a beam prediction model according to the beam measurement result and the beam characteristic information.

9. The method according to claim 1, further comprising:
in response to the target beam set comprising a target downlink transmit beam, sending a downlink signal to the terminal device on the target downlink transmit beam.

10. The method according to claim 1, further comprising:
in response to the target beam set comprising a target uplink receive beam, receiving an uplink signal sent by the terminal device on the target uplink receive beam.

11. A beam selection method, performed by a terminal device and comprising:
sending a beam measurement result of a reference beam to an access network device; and
determining beam characteristic information of a used receive beam, wherein the beam characteristic information and the beam measurement result are used for determining a target beam set.

12. The method according to claim 11, wherein determining the beam characteristic information of the used receive beam comprises:
receiving first beam indication information sent by the access network device; and
determining the beam characteristic information of the used receive beam according to the first beam indication information,
wherein the first beam indication information comprises at least one of:
beam angle of direction information;
half-power beam width; or
quasi-co-location QCL information.

13. The method according to claim 12, wherein receiving the first beam indication information sent by the access network device comprises:
receiving a first RRC signaling sent by the access network device, wherein the first RRC signaling comprises the first beam indication information.

14. The method according to claim 13, wherein receiving the first RRC signaling sent by the access network device comprises:
receiving CSI resource configuration information sent by the access network device, wherein the CSI resource configuration information comprises the first beam indication information.

15. The method according to claim 11, wherein determining the beam characteristic information of the used receive beam comprises:
sending second beam indication information to the access network device, wherein the second beam indication information is used for determining the beam characteristic information of the used receive beam,
wherein the second beam indication information comprises at least one of:
beam angle of direction information;
half-power beam width; or
quasi-co-location QCL information.

16. The method according to claim 15, wherein sending the second beam indication information to the access network device comprises:
sending a first UCI signaling to the access network device, wherein the first UCI signaling comprises the second beam indication information.

17. The method according to claim 16, wherein sending the first UCI signaling to the access network device comprises:
sending CSI to the access network device, wherein the CSI comprises the second beam indication information.

18. The method according to claim 11, further comprising:
in response to the target beam set comprising a target downlink receive beam, receiving a downlink signal sent by the access network device on the target downlink receive beam.

19.-21. (canceled)

22. A communication device, comprising a processor and a memory, the memory having a computer program stored therein, wherein
the processor executes the computer program stored in the memory, so that the communication device performs a beam selection method, comprising:
receiving a beam measurement result of a reference beam sent by a terminal device;
acquiring beam characteristic information of a receive beam used by the terminal device; and
determining a target beam set according to the beam measurement result and the beam characteristic information.

23.-24. (canceled)

25. A communication device, comprising a processor and a memory, the memory having a computer program stored therein, wherein
the processor executes the computer program stored in the memory, so that the communication device performs the method according to claim 11.
